(19) United States
(12) Patent Application Publication
(10) Pub. No.: US 2003/0168847 A1
(43) Pub. Date: Sep. 11, 2003

(54) Bookmark including elastic member attached thereto

(76) Inventor: Ralph Palamidessi, Marina, CA (US)

Correspondence Address: DICKSTEIN SHAPIRO MORIN & OSHINSKY LLP, Steven I. Weisburd, 41st Floor, 1177 Avenue of the Americas, New York, NY, 10036-2714, US

(21) Appl. No.: 10/347,218

(22) Filed: Jan. 21, 2003

Related U.S. Application Data
(60) Provisional application No. 60/363,387, filed on Mar. 11, 2002.

(51) Int. Cl. B42D 9/00

(52) U.S. Cl. 281/42

(57) ABSTRACT

A bookmark includes a rectangular solid base portion and an elastic member coupled to the base portion at only one end. The elastic member is an endless loop has a ball at one end and is fed through an opening at the end of the base portion. In use, the base portion is inserted into the inside of a book and the elastic member is extended around an outside of the book.

### CROSS REFERENCE TO RELATED APPLICATIONS

This application claims priority to provisional application No. 60/363,387 filed Mar. 11, 2002; the entirety of which is hereby incorporated by reference.

### BACKGROUND OF THE INVENTION

The invention relates to a bookmark and, more particularly, to a bookmark including an elastic member attached thereto, so that the bookmark has increased utility unavailable in the prior art.

Prior art bookmarks are typically rectangular solid placard members which are placed within a book to mark a page for a user. Some of these bookmarks include a flag attached to the placard so that the position of the bookmark can be found more easily. However, if the book which is holding the bookmark is jarred or moved significantly, the bookmark can easily fall out of the book thereby losing its function and utility. Additionally, while the bookmark is stored in the book, there is no device protecting the pages of the book from being curled or ruffled due to rough usage of the book.

Other prior art bookmarks, like those shown in U.S. Pat. No. 370,525 and U.S. Pat. No. 5,622,387 include a base portion disposed in a book and a means for attaching the base portion to the book. However, the base portion in these prior art patents is irregularly shaped—i.e. not a rectangular solid. Bookmark users are accustomed to bookmarks which are rectangular solids. Additionally, store displays which sell bookmarks are designed to hold bookmarks with which are rectangular solids and such displays would have to be redesigned in order to hold some of these prior art bookmarks.

Still other prior art bookmarks like those shown in U.S. Pat. No. 4,98,115 and U.S. Pat. No. 6,109,204, show a base portion and a means for attaching the base portion to a book. However, the base portion is disposed outside of the book, external to the cover of the book, and so creates an unpleasant distortion of the book shape to a user. Additionally, users are not accustomed to placing bookmarks on the outside of books. Finally, the means for affixing the base portions in these prior art patents is generally cumbersome involving levers, tightening means, VELCRO, or requiring the user to repeatedly fasten and unfasten knots. Users of books typically do not wish to be so inconvenienced when merely placing a bookmark into a book.

Thus, there is a need in the art for a bookmark which is sized, shaped and used in accordance with standard book user norms and which includes a mechanism for retaining the bookmark within a book.

### BRIEF DESCRIPTION OF THE DRAWINGS

FIG. 1 is a front view of a bookmark in accordance with the invention.

FIGS. 2a, 2b and 2c are front views showing a bookmark being inserted and retained in a book in accordance with the invention.

### SUMMARY OF THE INVENTION

A bookmark includes a rectangular solid base portion and an elastic member coupled to the base portion at only one end. The elastic member is an endless loop, has a fastner at one end and is fed through an opening at the end of the base portion. In use, the base portion is inserted into the inside of a book and the elastic member is extended around an outside of the book.

### DETAILED DESCRIPTION OF PREFERRED EMBODIMENTS

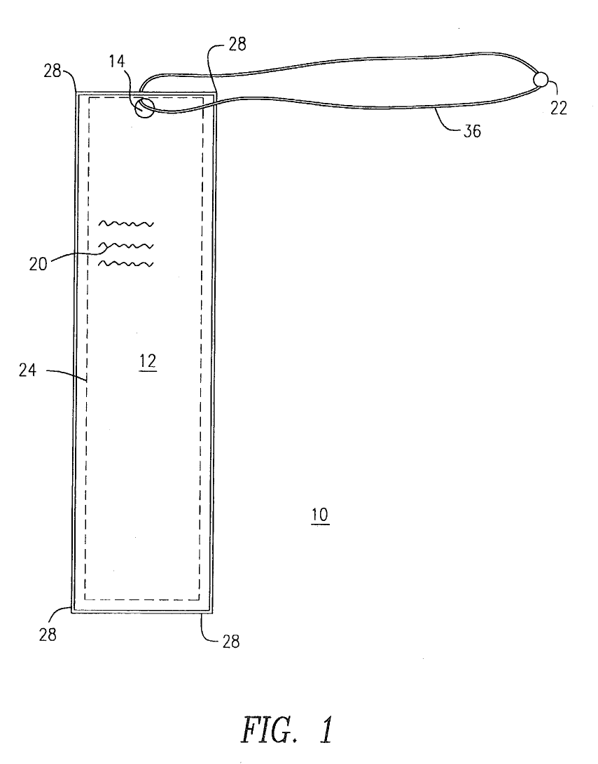

As shown in FIG. 1, a bookmark 10 in accordance with the invention includes a base portion 12 including an opening 14 disposed at one end. Base portion 12 has a generally rectangular solid shape and is made of flexible material such as 20 ga. polypropylene. Edges 28 of base 12 may be rounded. Base portion 12 may be clear, matted, and/or have a texture disposed thereon. Information 20 may be off-set printed or screen printed on base 12 using UV inks. A second base portion 24 (shown in phantom) may be disposed behind base portion 12 and used to, for example, provide information (not shown) regarding bookmark 10. Second base portion 24 may be of the same shape as base 12 and may be made of a thinner material (e.g. paper) so that it can be easily torn off once information on it is read. Opening 14 preferably extends through both base 12 and base 24.

A pliant resilient elastic member 36 is coupled to base 12 through opening 14. Member 36 may be, for example, a sixteen (16) inch endless loop with a silver ball 22 at one end. Ball 22 provides a weight which prevents member 36 from becoming tangled.

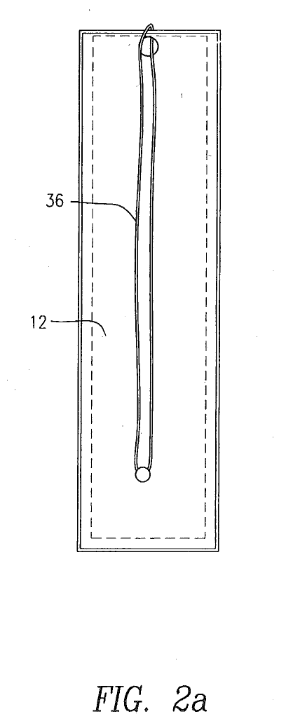

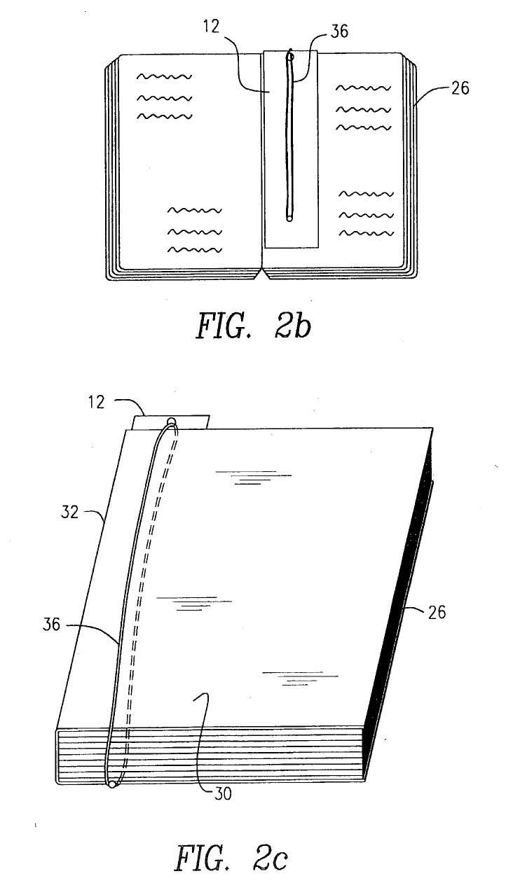

Referring now to FIGS. 2a, 2b, and 2c, in use, base 12 is positioned at a desired location in a book 26. Thereafter, elastic member 36 is stretched around the outer cover 30 of book 26. In this position, bookmark 10 retains a position in the book which is desired by the user and bookmark 10 is inhibited from being dislodged or removed from book 26. If bookmark 10 is disposed toward spine 32 of book 26 and placed around one cover of the book, bookmark 10 is retained within the book and the book may still be opened and read by user. If bookmark 10 is placed distal from spine 32 of the book, bookmark 10 may be used to keep book 26 closed and to inhibit a ruffling of the pages of the book. Such flexibility in positioning of a bookmark is not available in the prior art. As elastic member 36 is both resilient and pliant, member 36 and bookmark 10 may be used with a variety of different sized books including paperbacks, hard-covered text books, magazines and journals. As base 12 is pliant, base 12 allows member 36 to follow the contour of a book—especially paperback books.

Thus, by providing a rectangular solid base portion and coupling an elastic member at one end of the base portion, a bookmark which can substantially correspond to users accustomed dimensions and uses and which can be reliably retained within a book—is achieved.

What is claimed is:

1. A combination of a bookmark and a book, the combination comprising:
a book having an inside and an outside; and
a bookmark;
the bookmark comprising:
a rectangular solid base portion, the base portion being disposed in the inside of the book; and
an elastic member coupled to the base portion at only one end of the base portion, the elastic member being an endless loop and being disposed around an outside of the book.

2. The combination as recited in claim 1, wherein the base portion includes a void therein and the elastic member extends through the void so as to be retained therein by walls defining the void.

3. The combination as recited in claim 1, wherein the base portion is made of polypropylene.

4. The combination as recited in claim 1, wherein the bookmark and elastic member are disposed proximate to a spine of the book so that the book may be opened.

5. The combination as recited in claim 1, wherein the bookmark and elastic member are disposed distal from a spine of the book so that the book is inhibited from being opened.

6. The combination as recited in claim 1, wherein edges of the base portion are rounded.

7. The combination as recited in claim 1, wherein the base portion includes information printed thereon.

8. The combination as recited in claim 1, wherein the elastic member includes a ball at an end thereof.

9. A method for inserting a bookmark into a book, the book having an inside and an outside, the bookmark including a rectangular solid shaped base portion and an elastic member coupled to the base portion at only one end, the elastic member being an endless loop, the method comprising:
inserting the base portion of the bookmark into an inside of the book; and
extending the elastic member around an outside of the book.

10. The method as recited in claim 9, wherein the base portion includes a void therein and the extending includes extending the elastic member through the void so as to be retained therein by walls defining the void.

11. The method as recited in claim 9, wherein the base portion is made of polypropylene.

12. The method as recited in claim 9, wherein the inserting and extending are performed so that the base and elastic member are proximate to a spine of the book whereby the book may be opened.

13. The method as recited in claim 9, wherein the inserting and extending are performed so that the base and elastic member are distal from a spine of the book whereby the book is inhibited from being opened.
